(19) United States
(12) Patent Application Publication
(10) Pub. No.: US 2006/0093470 A1
(43) Pub. Date: May 4, 2006

(54) Turbine distributor part supplied with cooling air

(75) Inventors: Sabine Bermond, Paris (FR); Alexandre Dervaux, Paris (FR); Jean-Michel Guimbard, Cely En Biere (FR); Gael Loro, Combs La Ville (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, PARIS (FR)

(21) Appl. No.: 11/260,183

(22) Filed: Oct. 28, 2005

(30) Foreign Application Priority Data
Oct. 29, 2004 (FR) 04 11575

(51) Int. Cl. F03B 11/00

(52) U.S. Cl. 415/115

(57) ABSTRACT

The invention relates to a part (110) of the distributor of the first stage of a turbojet low-pressure turbine. A part of this type comprises an outer platform segment (104) and an inner platform segment (102) between which a plurality of hollow blades (106), intended to be supplied with cooling air, extend, a cap (132) covering a base portion (138) of the outer platform segment (104) so as to define with this base portion a chamber (140), which communicates with the interior of said blades (106) via communication openings (130), air inlets (137) being provided in said cap (132) in order to allow said chamber (140) to be supplied with cooling air.

The invention relates to a turbine distributor part and to a turbine engine equipped with a turbine, the distributor of which results from the assembly of a plurality of parts of this type. The invention may relate to any type of turbine intended to be fitted to any type of turbine engine (naval air or land based). However, the invention relates primarily to gas turbines and, more particularly, to turbines fitted to aeroplane turbojets.

A turbojet generally comprises, in the usual direction of flow of the air stream passing through it, one or two compressors, a combustion chamber and one or two turbines. A distinction is drawn between single-spool turbojets, which comprise a compressor and a turbine, and twin-spool turbojets, which comprise two compressors, referred to as the low-pressure compressor and the high-pressure compressor, and two turbines, also referred to as the low-pressure turbine and the high-pressure turbine. There are also triple-spool turbojets, which comprise three turbines: a low-pressure turbine, a high-pressure turbine and what is known as an intermediate turbine.

Similarly, a distinction is drawn between single-stream turbojets and twin-stream turbojets. Said twin-stream turbojets, rather than having a single air stream passing through them, are passed through by what is known as a primary stream, which passes through the members of the turbine, and what is known as a secondary stream, which circulates between the case of said members and the fairing of the turbojet.

A turbojet turbine comprises fixed elements (stator) and movable elements (rotor). The movable elements are movable wheels that carry blades inserted between grates of fixed blades, also referred to as a distributor. The distributor/movable wheel pairing forms a turbine stage. In order to facilitate assembly of the turbine, the distributors are obtained by means of assembly of at least two distributor parts.

In view of the temperature of the gases passing through the turbine, the blades of some distributors are hollow, so that they may be cooled. This is generally the case in twin-spool turbojets, for the blades of the first distributor of the turbine in the direction of flow of the gases, or distributors of the first stage.

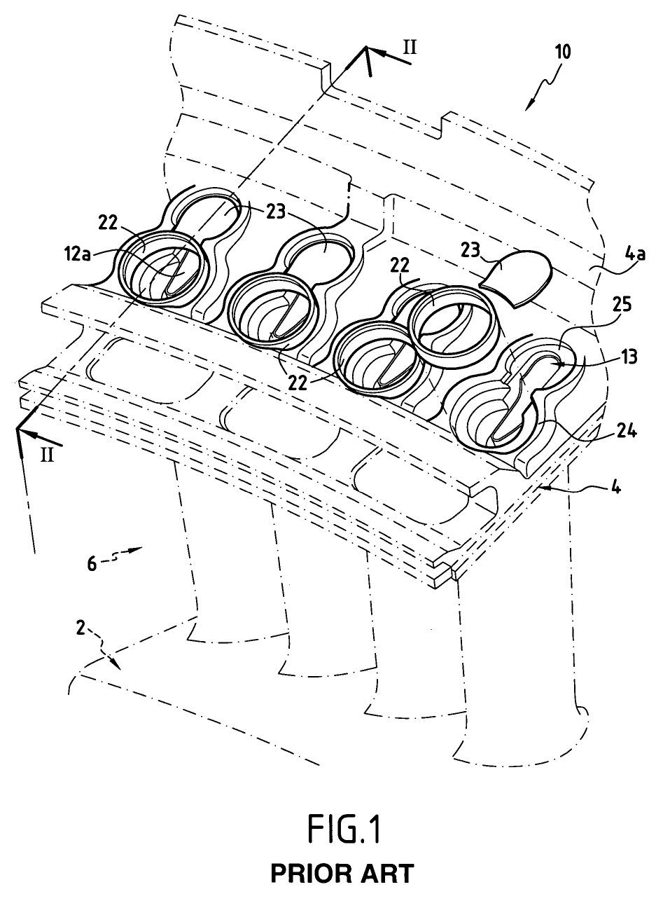

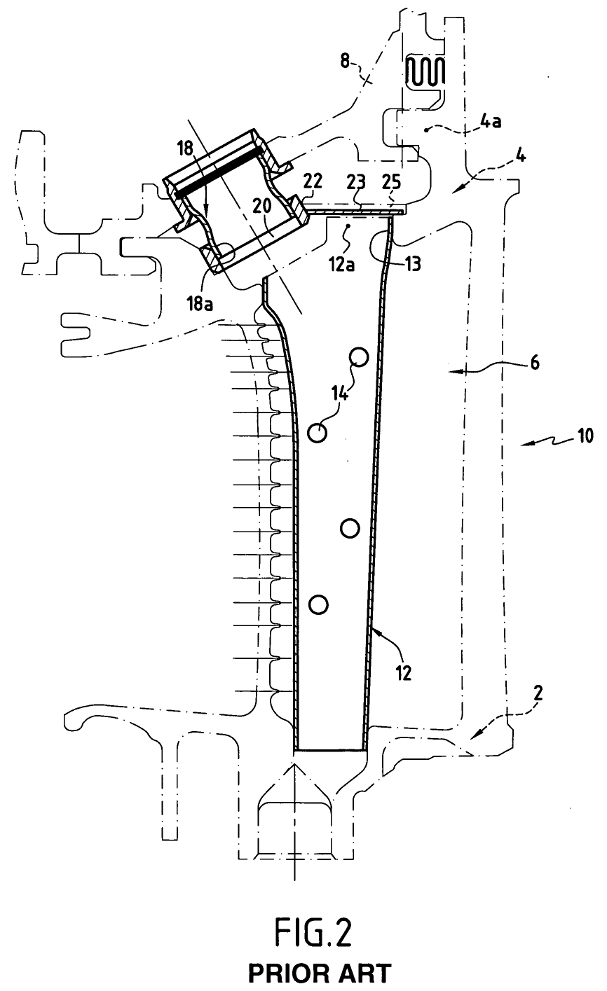

FIG. 1 is a perspective view of an example of a turbine distributor part 10 of the known type, and FIG. 2 is a radial section along the plane II-II of the part 10 of FIG. 1. This part 10 comprises an inner ring segment 2 and an outer ring segment 4 between which four blades 6, which are intended to orientate the air stream in a direction that is beneficial for driving the adjacent movable wheel (not shown), extend. In order to form a distributor, 24 parts of this type are joined together. Once they have been assembled, the segments 2 form a ring known as the inner platform of the distributor, and the segments 4 form a ring known as the outer platform of the distributor (it will be noted that said platforms are therefore not flat, but rather annular).

Each segment 4 of the outer platform of the distributor has lateral rims 4a, which allow the distributor to be fixed to the case 8. These rims 4a are more or less raised, and their shapes are configured so as to cooperate with complementary shapes formed on the case 8 of the turbojet.

The blades 6 are hollow, so that they may be passed through by cooling air. Moreover, a perforated sleeve 12, which is made, for example, from a metal sheet, is located inside each blade in order to improve cooling thereof. When it is fitted, this sleeve is slid inside an opening 13 formed in the outer ring 4. Each sleeve 12 is held in place as a result of its neck 12a being soldered to the edges of the opening 13.

The cooling air penetrates the interior of the blades 6 via the opening 13, passes via the sleeves 12 and issues via perforations 14 formed in the sleeves 12 so as to cool the inner walls of the blades 6 on impact. The air then escapes via perforations (not shown) formed in the blade 6 and thus joins the primary air stream passing through the turbine.

The cooling air, which is generally removed from the primary stream of the turbojet in the region of the high-pressure compressor, is directed up to each blade via a conduit 18. This conduit 18 is used to channel the cooling air stream toward the blade 6 and thus to prevent undesirable air leaks between the case 8 and the outer platform of the distributor.

As the cross section of the opening 13 is larger than that of the conduit 18, a portion of the opening 13 has to be closed and an air inlet 20, the shape of which corresponds precisely to that of the end of the conduit 18, created. It will be noted, in this case, that the cross section of the conduit 18 has to be sufficiently small to allow the flow rate of the air circulating inside this conduit to be sufficiently high.

Thus, for each opening 13, two elements are welded to the outer platform segment 4: a bush 22 and a plaque 23, the bush 22 forming the air inlet 20 and the plaque 23 closing a portion of the opening 13. These elements 22 and 23 are welded to the segment 4 once the sleeves 12 have been fitted. For a distributor part 10 comprising four blades 6, eight elements 22, 23 therefore have to be welded, thus rendering assembly a lengthy and complex process.

Moreover, in order to facilitate the positioning of the bush 22 and the plaque 23, the surface of the segment 4 has indented portions. A vent 24 is thus formed at the surface of the ring segment 4 in order to receive the bush 22, while a cavity 25 is formed for receiving the plaque 23. However, these indented portions 24, 25 are formed by means of casting and are obtained following complex, lengthy and expensive machining. The presence of the indented portions 24, 25 therefore increases the cost and the weight of the part 10 and renders the outer platform segment rigid in such a way that this segment 4 does not have the flexibility required to absorb the thermomechanical stresses to which it is subjected. It will be noted that the processes for welding the elements 22 and 23 also render the segment 4 rigid.

The object of the invention is to solve the aforementioned problems by proposing a turbine distributor part that is simple in structure, light and easy to assemble.

In order to achieve this object, the invention relates to a turbine distributor part comprising an outer platform segment and an inner platform segment between which a plurality of hollow blades, intended to be supplied with cooling air, extend, characterised in that a cap covers a base portion of the outer platform segment so as to define with this base portion an air inlet chamber common to said blades, which chamber communicates with the interior of said blades via communication openings, air inlets being provided in said cap in order to allow said chamber to be supplied with cooling air. The cooling air thus passes through said common air inlet chamber before supplying the interior of the blades.

The structure and the assembly of this distributor are simplified, as in this case only a single element is fitted to the outer platform segment: the cap. Furthermore, a chamber that is common to a plurality of blades, extending along this segment, is formed below the cap.

Moreover, the surface of said base portion does not have to have a complex indented portion in order to receive the cap. On the contrary, advantageously, this portion is substantially flat (although it does necessarily exhibit the curvature of the segment) and said communication openings are flush with the bottom of this portion.

The base portion is therefore simpler to form and lighter than in the prior art. Moreover, the cap is also easy to form and may be made from light elements such as metal sheets. A significant advantage in terms of weight and a simplification of the production process for the entire distributor segment are therefore achieved.

Accordingly, the cap is remote from the base portion of the outer platform segment, and since this portion does not have any specific indented portions, it is highly deformable. The flatter the bottom of the base portion, the greater this deformability.

Finally, the chamber formed between the cap and the base portion, which is intended to be filled with cooling air, will allow the space surrounding this chamber to be cooled by means of heat conduction.

A better understanding of the invention and its advantages will be facilitated by reading the following detailed description of an embodiment of the invention illustrated by way of a non-limiting example. The description will refer to the accompanying drawings, in which:

FIG. 1 is a perspective view of a turbine distributor part of the known type;

FIG. 2 is a radial section, along the plane II-II, of the part of FIG. 1, once it has been assembled;

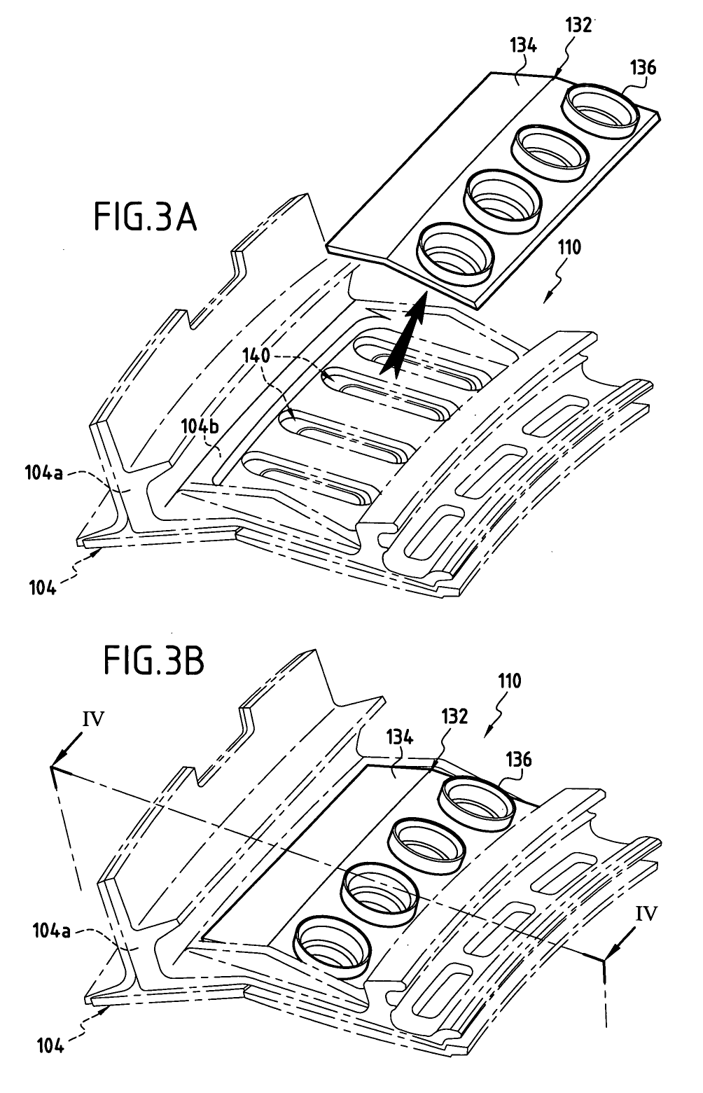

FIG. 3a is an exploded perspective view of a turbine distributor part according to the invention;

FIG. 3b is a perspective view of the turbine distributor part of FIG. 3a, once it has been assembled; and

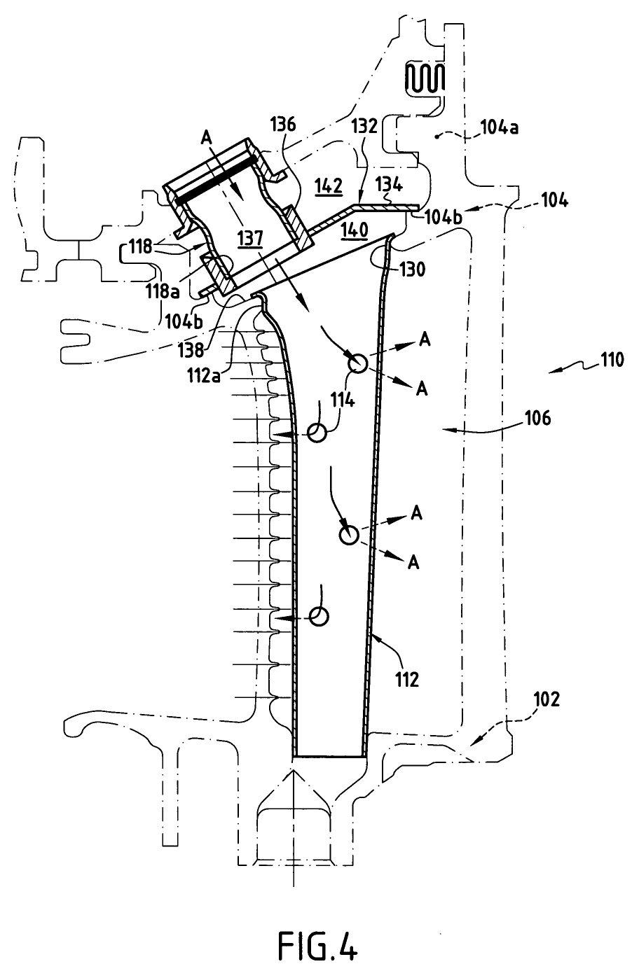

FIG. 4 is a radial section, along the plane IV-IV, of the part illustrated in FIG. 3b.

The distributor part according to the invention, which is denoted by the general reference numeral 110, is intended to be assembled with other parts of the same type in order to form a turbine distributor as a distributor of the first stage of a low-pressure turbine of a twin-spool, twin-stream aeroplane turbojet. However, it might be a distributor located at a different stage of the turbine, a high-pressure turbine distributor or else an intermediate turbine distributor (in the case of a triple-spool turbojet).

Similarly, it will be noted that the invention is not limited to distributor parts equipped with sleeves.

Since the part 110 comprises some elements similar to those of the part 10 of the known type, described above, these similar elements will be denoted by the same reference numerals increased by 100.

The part 110 thus comprises an outer platform segment 104 and an inner platform segment 102 between which four hollow blades 106 extend. A sleeve 112 is located inside each blade 106. The cross section of the sleeve 112 widens from the interior toward the exterior of the turbine (in the figure, from bottom to top) and is delimited at its outer end by a widened neck 112a defining a cooling air inlet. During assembly of the part 110, this sleeve 112 is slid inside an opening 130 formed in the ring segment 104, and its neck 112a is fixed, for example by welding, to the walls and/or to the edge of the opening 130.

The shape and the size of each of said communication openings 130 advantageously correspond to those of the neck 112a of each of the sleeves 112. It is therefore easy to fit each sleeve 112 inside each blade 106 and to fix the neck 112a of each sleeve 112 to the opening 130. This simplifies the assembly of the part 110.

The part 110 also comprises a cap 132 formed from a planar or folded panel 134 (as illustrated in the figures). A specific number of orifices, inside which bushes 136 are fitted, has been formed on this panel 134. The bushes 136 delimit air inlets 137 formed in the cap 132, through which inlets cooling air is intended to pass.

The cap 132, more specifically the peripheral edges of the panel 136, rests on shoulders 104b formed in the lateral rims 104a of the segment 104, above the base portion 138. These rims 104a surround the cap 132 on all of its sides and define, with the base portion 138 and the cap 132, the chamber 140.

The term “base portion” 138 refers to the most radially remote portion of the segment 104, which portion is located between the lateral rims 104a of the segment 104. The openings 130 of the blades 106 are formed in the region of the portion 138, and as this portion has substantially no indented portions (although it does exhibit a slight curvature, which is that of the outer platform), these openings 130 are flush with the bottom of the portion 138, as illustrated in FIGS. 3a and 4.

The chamber 140 communicates with the interior of the blades 106 via the communication openings 130. The chamber 140 is also supplied with cooling air via the inlets 137.

Connection conduits 118, which pertain to more general cooling air supply means, which remove cool air from the secondary air stream passing through the turbojet, are used for directing the cooling air up to the inlets 137.

Each air inlet 137 of the cap 132 exhibits a shape and size corresponding to those of one end 118a of the conduit 118 in such a way that said inlets may be connected to this end 118a. Thus, in the example, the shape and the size of the bushes 136 are suitable for receiving said end 118a of the conduit and for ensuring the maximum possible degree of tightness in the connection formed.

The cooling air circulates inside the ring part 104 in the direction of the arrows A. In order to ensure that the air is distributed effectively inside the blades 106, the number of air inlets 137 may be selected so as to be equal to that of the communication openings 130, and the inlets 137 and openings 130 may be located substantially facing one another, as illustrated in FIG. 3A.

The air inlets 137 may also be arranged between the communication openings 130 (in staggered configuration therewith); this ensures that the air is distributed effectively in each blade 106 and allows the number of inlets 137 of a unit to be reduced relative to the number of openings 130.

It is therefore possible for there to be fewer air inlets 137 than communication openings 130. This allows the structure of the distributor to be simplified and the production cost thereof to be reduced. A single air inlet 137, common to all of the communication openings 130, may thus be provided.

Under specific operating conditions of the turbojet, it will be noted that supplying the chamber 140 with cooling air allows a reduction in the heating of the portions of the distributor surrounding this chamber 140, that is, of course, the base portion 138 and the rims 104a of the outer platform segment 104, but also the space 142 that surrounds said chamber and, accordingly, the case 8.

1. Turbine distributor part comprising an outer platform segment and an inner platform segment between which a plurality of hollow blades, intended to be supplied with cooling air, extend, characterised in that a cap covers a base portion of the outer platform segment so as to define with this base portion a chamber common to said blades, which chamber communicates with the interior of these blades via communication openings, air inlets being provided in said cap in order to allow said chamber to be supplied with cooling air.

2. Turbine distributor part according to claim 1, characterised in that said chamber extends along the outer platform segment.

3. Turbine distributor part according to claim 1, characterised in that said base portion of the outer platform segment is substantially flat.

4. Turbine distributor part according to claim 1, characterised in that said communication openings are flush with the bottom of said base portion.

5. Turbine distributor part according to claim 3, characterised in that said communication openings are flush with the bottom of said base portion.

6. Turbine distributor part according to claim 1, characterised in that a perforated sleeve with a neck is located inside each blade, the shape and the size of each of said communication openings corresponding to those of the neck of each sleeve.

7. Turbine distributor part according to claim 1, characterised in that the number of air inlets is equal to the number of communication openings and in that these inlets and openings are located substantially facing one another.

8. Turbine distributor part according to claim 1, characterised in that the number of air inlets is less than the number of communication openings.

9. Turbine engine comprising at least one turbine equipped with a distributor, characterised in that said distributor results from the assembly of a plurality of distributor parts according to claim 1.

10. Turbine engine according to claim 9, characterised in that said turbine engine is a twin-spool turbojet comprising a high-pressure turbine and a low-pressure turbine, said distributor being the first distributor of the low-pressure turbine in the direction of flow of the air stream passing through this turbine.
